(19) United States
(12) Patent Application Publication
(10) Pub. No.: US 2005/0228145 A1
(43) Pub. Date: Oct. 13, 2005

(54) Polyamide 1/interlayer/polyamide 2 multilayer structures for decorated articles

(76) Inventors: Christophe Lacroix, Foulains (FR); Thibaut Montanari, Bernay (FR)

Correspondence Address: Thomas F. Roland, Esq.;Arkema Inc., 2000 Market St., Philadelphia, PA, 19103, US

(21) Appl. No.: 11/043,817

(22) Filed: Jan. 26, 2005

Related U.S. Application Data
(60) Provisional application No. 60/570,634, filed on May 13, 2004.

(30) Foreign Application Priority Data
Jan. 26, 2004 (FR) 04.00712

(51) Int. Cl. C08G 69/48

(52) U.S. Cl. 525/420

(57) ABSTRACT

The present invention relates to a transparent polyamide 1/interlayer/polyamide 2 multilayer structure manufactured by coextrusion. The invention also relates to a decorated article consisting of an object to which the above structure has been bonded, the polyamide 1 layer being on the outside. The bonding may be carried out by hot pressing or by using an adhesive.

This application claims benefit, under U.S.C. §119(a) of French National Application Number 04.00712, filed Jan. 26, 2004; and also claims benefit, under U.S.C. §119(e) of U.S. provisional application 60/570,634, filed May 13, 2004.

### FIELD OF THE INVENTION

The present invention relates to polyamide 1/interlayer/polyamide 2 multilayer structures for decorated articles. They are in the form of a film or sheet. The term “film” is normally used up to a thickness of about 0.5 mm and the term “sheet” beyond that. These structures may be bonded, for example by hot pressing, to an article such as a ski, the polyamide layer 1 being on the outside. In this case, the polyamide layer 1 forms the top of the ski. Before the polyamide 1/interlayer/polyamide 2 structure is bonded, the ski may be decorated beforehand on the top (that is to say on the opposite part from the sole that slides on the snow); thus, after the polyamide 1/interlayer/polyamide 2 structure (which is transparent) has been bonded, the decoration may be seen. It is also possible to decorate the ski after the polyamide 1/interlayer/polyamide 2 structure has been bonded to the ski, by subliming inks into the polyamide layer 1. It is also possible to combine these two methods of decoration.

According to another embodiment, the polyamide 1/interlayer/polyamide 2 structures may be bonded to a foam, possibly a polyurethane foam, and the structure obtained is useful, for example for making sports shoes.

According to another embodiment, the polyamide 1/interlayer/polyamide 2 structures may be bonded to a substrate other than a ski (for example a rigid polyurethane substrate) and the structure obtained is useful, for example for making various articles.

### BACKGROUND OF THE INVENTION

Patents U.S. Pat. No. 5,616,418 and U.S. Pat. No. 5,506,310 disclose a structure consisting in succession of a polyamide layer, a layer made of a polyamide elastomer/grafted polyolefin blend and a layer that may be made of wood, from a metal, epoxy or polyurethane. This structure may be a ski, that is to say the epoxy or polyurethane layer is not a thermoplastic layer but is the core of the ski. This part of the ski is not thermoplastic—the epoxy resin is crosslinked even if it is a polyurethane, i.e. a rigid polyurethane.

The object of the invention is to provide a sheet (for example the top of a ski) having the following advantages:
1) the upper surface is scarcely scratchable, which implies a sufficient rigidity; in addition, this sheet must be mechanically durable (impact-resistant), chemically resistant and UV-resistant;
2) the sheet is sufficiently flexible and deformable to be shaped (typically, but not necessarily, performed hot) to the shape of the ski, and also to be able to be placed properly flat in order to be accurately decorated;
3) the lower surface can be hot-decorated by sublimation, which implies a semicrystalline polymer having a high enough melting point (sublimation takes place at a temperature below the melting point, since the material must not melt, but above the T_{g}, since the polymer must have sufficient mobility for the inks to migrate properly);
4) the sheet is sufficiently transparent to be decorated on the lower face (thereby protecting the decoration from external attack);
5) another parameter is decorability by screen printing, which requires a lower face to adhere well to the screen-printing inks; and
6) another parameter is the ability of the lower layer to be easily joined to any type of substrate, for the purpose of decorating this substrate.

### SUMMARY OF THE INVENTION

The present invention relates to a transparent polyamide 1/interlayer/polyamide 2 multilayer structure. This structure may be manufactured by coextrusion.

The invention also relates to a decorated article consisting of an object to which the above structure has been bonded, the polyamide 1 layer being on the outside. The bonding may be carried out by hot pressing or by using an adhesive. The decoration may already exist on the object before the structure is bonded; it is also possible to decorate the polyamide layer by sublimation of inks or by combining these two methods of decoration. The object is for example a ski.

According to another embodiment, the polyamide 1/interlayer/polyamide 2 structures may be bonded to a foam, possibly a polyurethane foam, or to a resin, possibly polyurethane resin. It is also possible to overmould the foam or the resin onto the polyamide 1/interlayer/polyamide 2 structure placed in a mould, the polyamide 1 layer being adjacent to the mould wall.

The structure obtained is useful, for example for making skis or sports shoes. The invention also relates to these objects. Advantageously, the polyamide 1 layer is semicrystalline.

Each of the layers may be formed from several layers.

The structure of the invention has many advantages. The polyamide 1 layer provides:
abrasion resistance;
impact strength, especially cold impact strength;
the possible decoration by sublimation of inks thanks to its high melting point (or glass transition temperature), whereas the TPU and TPU/ABS blends cannot be decorated by sublimation of inks;
complete transparency with semiaromatic or semicycloaliphatic (PAs) and their possible blends with aliphatic polyamides of the PA-11 or PA-12 type;
UV and chemical resistance
glossy appearance; and
smooth feel.

### DETAILED DESCRIPTION OF THE INVENTION

With regard to the polyamide 1 layer, this comprises at least one polyamide chosen from semiaromatic or semicycloaliphatic PAs and aliphatic polyamides.

The aliphatic polyamides may be chosen from PA-11, PA-12, aliphatic polyamides resulting from the condensation of an aliphatic diamine having from 6 to 12 carbon atoms and of an aliphatic diacid having from 9 to 12 carbon atoms, and 11/12 copolyamides having either more than 90% of 11 units or more than 90% of 12 units.

By way of example of aliphatic polyamides resulting from the condensation of an aliphatic diamine having from 6 to 12 carbon atoms and of an aliphatic diacid having from 9-12 carbon atoms, mention may be made of:
PA-6,12 resulting from the condensation of hexamethylenediamine and 1,12-dodecanedioic acid;
PA-9,12 resulting from the condensation of the C₉ diamine and 1,12 dodecanedioic acid;
PA-10,10 resulting from the condensation of the C₁₀ diamine and 1,10-decanedioic acid; and
PA-10,12 resulting from the condensation of the C₉ diamine and 1,12-dodecanedioic acid.

As regards the 11/12 copolyamides having either more than 90% of 11 units or more than 90% of 12 units, these result from the condensation of 1-amino-undecanoic acid with lauryllactam (or of the C₁₂ α,ω-amino acid).

The polyamide layer may also include copolymers having polyamide blocks and polyether blocks, but it is advantageous that this be in a proportion that does not impair the transparency of this layer.

The copolymers having polyamide blocks and polyether blocks result in general from the copolycondensation of polyamide blocks having reactive end groups with polyether blocks having reactive end groups, such as, inter alia:
1) polyamide blocks having diamine chain ends with polyoxyalkylene blocks having dicarboxylic chain ends;
2) polyamide blocks having dicarboxylic chain ends with polyoxyalkylene blocks having diamine chain ends, obtained by cyanoethylation and hydrogenation of aliphatic dihydroxylated α,ω-polyoxyalkylene blocks called polyetherdiols; and
3) polyamide blocks having dicarboxylic chain ends with polyetherdiols, the products obtained being, in this particular case, polyetheresteramides. The copolymers of the invention are advantageously of this type.

The polyamide blocks having dicarboxylic chain ends derive, for example, from the condensation of polyamide precursors in the presence of a dicarboxylic acid chain stopper.

The polyamide blocks having diamine chain ends derive, for example, from the condensation of polyamide precursors in the presence of a diamine chain stopper.

The polymers having polyamide blocks and polyether blocks may also include randomly distributed units. These polymers may be prepared by the simultaneous reaction of the polyether with the polyamide block precursors.

For example, it is possible to react a polyetherdiol, polyamide precursors and a diacid chain stopper. What is obtained is a polymer having essentially polyether blocks and polyamide blocks of very variable length, but also the various reactants, having reacted in a random fashion, which are distributed randomly along the polymer chain.

It is also possible to react a polyetherdiamine, polyamide precursors and a diacid chain stopper. What is obtained is a polymer having essentially polyether blocks and polyamide blocks of very variable length, but also the various reactants, having reacted in a random fashion, which are distributed randomly along the polymer chain.

The amount of polyether blocks in these copolymers having polyamide blocks and polyether blocks is advantageously from 10 to 70% and preferably from 35% to 60% by weight of the copolymer.

The polyether diol blocks are either used as such and copolycondensed with carboxyl-terminated polyamide blocks or they are aminated in order to be converted into polyetherdiamines and condensed with carboxyl-terminated polyamide blocks. They may also be blended with polyamide precursors and a diacid chain stopper in order to make the polymers having polyamide blocks and polyether blocks having randomly distributed units.

The number-average molar mass \overline{M}ₙ of the polyamide blocks is between 500 and 10000 and preferably between 500 and 4000 except for the polyamide blocks of the second type. The mass \overline{M}ₙ of the polyether blocks is between 100 and 6000 and preferably between 200 and 3000.

These polymers having polyamide blocks and polyether blocks whether they derive from the copolycondensation of polyamide and polyether blocks that were prepared beforehand or from a one-step reaction have, for example, an intrinsic viscosity, measured in methacresol at 25° C. for an initial concentration of 0.8 g/100 ml, of between 0.8 and 2.5.

Mention may be made, for example, of the composition comprising, by weight:
a) from 1 to 99%, preferably 5 to 95%, of a first polyamide characterized by the following chain sequences: 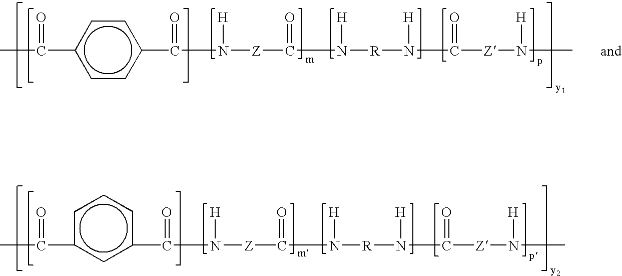
in which:
   y₁ and y₂ are numbers such that their sum y₁+y₂ is between 10 and 200 and y₁/y₁+y₂=0.5;
   m, p, m′, p′ are numbers equal to or greater than 0;
   Z and Z′ in the —NH-Z-CO— and —NH-Z′-CO aliphatic units, which are identical or different, are either a polymethylene segment —(CH₂)—ₙ n where n is an integer equal to or greater than 6 and preferably between 7 and 11, or a sequence containing an amide functional group resulting from the approximately stoichiometric condensation of one or more aliphatic diamines containing at least 4 carbon atoms between the amine functional groups and of one or more aliphatic dicarboxylic acids containing at least 4, and preferably at least 6, carbon atoms between the acid functional groups; —HN—R—NH— is a cycloaliphatic and/or aliphatic and/or arylaliphatic diamine; it being possible for the aromatic diacid to be replaced by up to 30 mol % with an aliphatic dicarboxylic acid containing more than 4, preferably 6, carbon atoms between the acid functional groups; and
b) 99 to 1%, preferably 95 to 5% of a semi-crystalline polyamide comprising at least 35%, preferably 50%, by weight of an aliphatic unit defined by the sequence —NH—(CH₂)_{n′}—CO— where n′ is an integer equal to or greater than 6 and preferably between 7 and 11, optionally as part of a semiaromatic unit, and/or of an aliphatic unit defined by the sequence containing an amide functional group resulting from the approximately stoichiometric condensation or one or more aliphatic diamines containing at least 4 carbon atoms between the amine functional groups and of one or more aliphatic dicarboxylic acids containing at least 4, and preferably at least 6, carbon atoms between the acid functional groups, that can be obtained using a process that includes a step of blending the said first polyamide and the said semi-crystalline polyamide at a temperature above 300° C., preferably between 300 and 400° C. The semicrystalline polyamide is preferably chosen from the abovementioned aliphatic polyamides and is advantageously PA-11 or PA-12.

Advantageously, this composition comprises, by weight:
40 to 90% of the said first polyamide; and
60 to 10% of the said semicrystalline polyamide.

Preferably, the composition comprises, by weight:
50 to 80% of the said first polyamide; and
50 to 20% of the said semicrystalline polyamide.

Mention may also be made of the polyamide composition comprising a semicrystalline polyamide and a sufficient amount of amorphous polyamide having a glass transition temperature and having no phase change, in order to make it transparent and able to be processed hot without deformation, that can be obtained by blending its constituents at a temperature greater than or equal to 300° C. and by conversion at a temperature greater than or equal to 300° C., the transparency being such that the light transmission coefficient is greater than or equal to 50% measured at 700 nm and for a thickness of 2 mm.

Advantageously, this composition comprises, by weight:
65 to 80% of the said semicrystalline polyamide; and
35 to 20% of the said amorphous polyamide.

Preferably, this composition, comprises, by weight:
68 to 77% of the said semicrystalline polyamide; and
32 to 23% of the said amorphous polyamide.

The semicrystalline polyamide is preferably chosen from the abovementioned aliphatic polyamides and is advantageously PA-11 or PA-12.

Mention may also be made of the transparent composition, comprising by weight, the total being 100%:
5 to 40% of an amorphous polyamide (B) that results essentially from the condensation:
   [symbol] either of at least one diamine chosen from cycloaliphatic diamines and aliphatic diamines and of at least one diacid chosen from cycloaliphatic diacid and aliphatic diacid, at least one of these diamine or diacid units being cycloaliphatic,
   [symbol] or of a cycloaliphatic α,ω-aminocarboxylic acid,
   [symbol] or of a combination of these two possibilities and
   [symbol] optionally, at least one monomer chosen from α,ω-aminocarboxylic acids or their possible corresponding lactams, aliphatic diacids and aliphatic diamines;
      0 to 40% of a flexible polyamide (C) chosen from copolymers having polyamide blocks and polyether blocks, and copolyamides;
      0 to 20% of a compatibiliser (D) for (A) and (B);
      0 to 40% of a flexible modifier (M);
      with the condition that (C)+(D)+(M) is between 0 and 50%;
      the balance to 100% being a semicrystalline polyamide (A).

The semicrystalline polyamide is preferably chosen from the abovementioned aliphatic polyamides and is advantageously PA-11 or PA-12.

Mention may also be made of the transparent composition comprising, by weight, the total being 100%:
5 to 40% of an amorphous polyamide (B) that results essentially from the condensation of at least one possibly cycloaliphatic diamine, of at least one aromatic diacid and optionally of at least one monomer chosen from:
   α,ω-aminocarboxylic acids,
   aliphatic diacids, and
   aliphatic diamines;
0 to 40% of a flexible polyamide (C) chosen from copolymers having polyamide blocks and polyether blocks, and copolyamides;
0 to 20% of a compatibiliser (D) for (A) and (B);
(C)+(D) is between 2 and 50%;
with the condition that (B)+(C)+(D) is not less than 30%;
the balance to 100% being a semicrystalline polyamide (A).

The semicrystalline polyamide is preferably chosen from the abovementioned aliphatic polyamides and is advantageously PA-11 or PA-12.

In these last two compositions, the terms “transparent”, “polyamide”, “semi crystalline” and “amorphous” have the following definitions:
the term “transparent” corresponds to a light transmission coefficient of greater than or equal to 50%, measured at 560 nm and for a thickness of 2 mm. Preferably it is greater than or equal to 80%;
the term “polyamide” employed in the present description also covers copolyamides, possibly containing third monomers in a proportion that does not impair the essential properties of the polyamides;
the term “semi crystalline” covers (co)polyamides having both a glass transition temperature T_{g} and a melting point Tₘ; and
the term “amorphous” covers polyamides that pass into the liquid or molten state, and therefore can be processed, above their T_{g}. These polymers do not have a priori a Tₘ in DSC. However, they may have a Tₘ, but its intensity is then negligible and does not impair the essentially amorphous character of the polymer.

Mention may also be made of PA-11 or PA-12 blends containing 10 to 40%, advantageously 15 to 35% and preferably 20 to 35% by weight of semiaromatic or semicycloaliphatic polyamide.

With regard to the interlayer, this is made of a very flexible polymeric material. This interlayer must of course adhere to the upper and lower layers so as to obtain a cohesive article.

Advantageously (but not necessarily), this interlayer is chosen:
to be as transparent as possible;
to have not too low an HDT, in order for the sheet not to creep during the hot operations for manufacturing the ski; and
to have good UV resistance (alternatively a UV absorber may be added to the upper layer, which thus protects the interlayer from UV).

As examples of this interlayer, mention may be made of products that can be used as ties, such as coextrusion ties.

Advantageously, the tie is a functionalized polyolefin carrying a carboxylic acid or carboxylic acid anhydride functional group. This functionalized polyolefin may be blended with an unfunctionalized polyolefin. To simplify matters, functionalized polyolefins (B1) and unfunctionalized polyolefins (B2) will be described below.

An unfunctionalized polyolefin (B2) is conventionally a homopolymer or a copolymer of alpha-olefins or diolefins, such as, for example, ethylene, propylene, 1-butene, 1-octene and butadiene. By way of examples, mention may be made of:
ethylene homopolymers and copolymers, particularly LDPE, HDPE, LLDPE (linear low-density polyethylene) or VLDPE (very low-density polyethylene) and metallocene polyethylene;
propylene homopolymers and copolymers;
ethylene/alpha-olefin copolymers such as ethylene/propylene copolymers; EPRs (abbreviation for ethylene-propylene rubbers); and ethylene/propylene/diene copolymers (EPDM);
styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);
copolymers of ethylene with at least one product chosen from salts or esters of unsaturated carboxylic acids such as alkyl (meth)acrylate (for example methyl acrylate), or vinyl esters of saturated carboxylic acids such as vinyl acetate, the proportion of comonomer possibly being as much as 40% by weight.

The functionalized polyolefin (B1) may be an alpha-olefin polymer having reactive units (the functional groups); such reactive units are acid or anhydride functional groups. By way of example, mention may be made of the above polyolefins (B2) which are grafted or are copolymerized or terpolymerized by carboxylic acids or the corresponding salts or esters, such as (meth)acrylic acid or else with carboxylic acid anhydrides such as maleic anhydride. A functionalized polyolefin is, for example, a PE/EPR blend, the weight ratio of which may vary between wide limits, for example between 40/60 and 90/10, the said blend being cografted with an anhydride, especially maleic anhydride, with a degree of grafting, for example, of 0.01 to 5% by weight.

The functionalized polyolefin (B1) may be chosen from the following (co)polymers, grafted with maleic anhydride, in which the degree of grafting is, for example, from 0.01 to 5% by weight:
PE, PP, copolymers of ethylene with propylene, butene, hexene, or octene and containing, for example, from 35 to 80% by weight of ethylene;
ethylene/alpha-olefin copolymers such as ethylene/propylene copolymers; EPRs (abbreviation for ethylene-propylene rubbers); and ethylene/propylene/diene copolymers (EPDM);
styrene/ethylene-butylene/styrene block copolymers (SEBS), styrene/butadiene/styrene block copolymers (SBS), styrene/isoprene/styrene block copolymers (SIS), styrene/ethylene-propylene/styrene block copolymers (SEPS);
ethylene/vinyl acetate copolymers (EVA), containing up to 40% by weight of vinyl acetate;
ethylene/alkyl (meth)acrylate copolymers, containing up to 40% by weight of alkyl (meth)acrylate;
ethylene/vinyl acetate (EVA)/alkyl (meth)acrylate copolymers, containing up to 40% by weight of comonomers.

The functionalized polyolefin (B1) may also be a copolymer or terpolymer of at least the following units: (1) ethylene, (2) an alkyl (meth)acrylate or a vinyl ester of a saturated carboxylic acid and (3) an anhydride such as maleic anhydride or a (meth)acrylic acid.

By way of examples of functionalized polyolefins of this latter type, mention may be made of the following copolymers, in which the ethylene preferably represents at least 60% by weight and in which the termonomer (the functional group) represents, for example, from 0.1 to 10% by weight of the copolymer:
ethylene/alkyl (meth)acrylate/(meth)acrylic acid or maleic anhydride copolymers;
ethylene/vinyl acetate/maleic anhydride copolymers;
ethylene/vinyl acetate or alkyl (meth)acrylate/(meth)acrylic acid or maleic anhydride copolymers.

The term “alkyl (meth)acrylate” in (B1) or (B2) denotes C₁ to C₁₂ alkyl methacrylates and acrylates, and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

The copolymers mentioned above, (B1) and (B2), may be copolymerized in a random or block fashion and may have a linear or branched structure.

The molecular weight, the MFI index and the density of these polyolefins may also vary over a wide range, as those skilled in the art will appreciate. MFI is the abbreviation for Melt Flow Index. It is measured according to the ASTM 1238 standard.

Advantageously, the unfunctionalized polyolefins (B2) are chosen from polypropylene homopolymers or copolymers and any ethylene homopolymer or copolymer of ethylene and a comonomer of alpha-olefin type, such as propylene, butene, hexene, octene or 4-methyl-1-pentene. Mention may be made, for example, of high-density PP and PE, medium-density PE, linear low-density PE, low-density PE and very low-density PE. These polyethylenes are known to those skilled in the art as being produced by a “radical” process, by “Ziegler”-type catalysis or, more recently, by so-called “metallocene” catalysis.

Advantageously, the functionalized polyolefins (B1) are chosen from any polymer comprising alpha-olefin units and units carrying polar reactive functional groups such as carboxylic acid or carboxylic acid anhydride functional groups. By way of examples of such polymers, mention may be made of ethylene/alkyl acrylate/maleic anhydride terpolymers, such as the LOTADER® polymers from the Applicant, or maleic-anhydride-grafted polyolefins such as the OREVAC® polymers from the Applicant, as well as ethylene/alkyl acrylate/(meth)acrylic acid terpolymers.

As other examples of this interlayer, mention may be made of TPUs (thermoplastic polyurethanes). These TPUs are formed from polyether soft blocks, which are polyetherdiol residues, and hard (polyurethane) blocks that result from the reaction of at least one diisocyanate with at least one short diol. The short chain extender diol may be chosen from the group formed from neopentyl glycol, cyclohexane dimethanol and aliphatic glycols of formula HO(CH₂)ₙOH in which n is an integer ranging from 2 to 10. The polyurethane blocks and the polyether blocks are linked by bonds resulting from the reaction of the isocyanate functional groups with the OH functional groups of the polyetherdiol.

Mention may also be made of polyester urethanes, for example those comprising diisocyanate functional units, units derived from amorphous polyesterdiols and units derived from a short chain extender diol. They may contain plasticizers.

The TPU may be a blend with copolymers having polyamide blocks and polyether blocks and/or vinylaromatic resins.

With regard to the vinylaromatic resin, the term “vinylaromatic monomer” is understood for the purpose of the present invention to mean an ethylenically unsaturated aromatic monomer such as styrene, vinyltoluene, α-methylstyrene, 4-methylstyrene, 3-methylstyrene, 4-methoxystyrene, 2-hydroxymethylstyrene, 4-ethylestyrene, 4-ethoxystyrene, 3,4-dimethylstyrene, 2-chlorostyrene, 3-chlorostyrene, 4-chloro-3-methylstyrene, 3-tert-butylstyrene, 2,4-dichlorostyrene, 2,6-dichlorostyrene and 1-vinylnaphthalene. The vinylaromatic resin is advantageously a styrene polymer.

As examples of styrene polymers, mention may be made of polystyrene, polystyrene modified by elastomers, styrene/acrylonitrile copolymers (SAN), SAN modified by elastomers, ABS, obtained for example by grafting (graft polymerization) of styrene and acrylonitrile onto a polybutadiene or butadiene-acrylonitrile copolymer backbone, SAN/ABS blends, ABS modified by elastomers, SAN modified by elastomers, and blends of SAN and ABS modified by elastomers. The abovementioned elastomers may, for example, be EPR (ethylene-propylene rubber or ethylene-propylene elastomer), EPDM (ethylene-propylene-diene rubber or ethylene-propylene-diene elastomer), polybutadiene, acrylonitrile-butadiene copolymer, polyisoprene and isoprene-acrylonitrile copolymer. These elastomers are used to improve the cold impact strength.

The impact polystyrene may be obtained either (i) by blending polystyrene with elastomers, such as polybutadiene, butadiene-acrylonitrile copolymers, polyisoprene or isoprene-acrylonitrile copolymers, or (ii) more usually by grafting styrene (graft polymerization) onto a polybutadiene or butadiene-acrylonitrile copolymer backbone.

In the styrene polymers that have just been mentioned, one part of the styrene may be replaced with unsaturated monomers that can be copolymerized with styrene, for example mention may be made of alpha-methyl styrene and (meth)acrylic esters. As examples of styrene copolymers, mention may also be made of polychlorostyrene, poly(α-methylstyrene), styrene-chlorostyrene copolymers, styrene-propylene copolymers, styrene-butadiene copolymers, styrene-isoprene copolymers, styrene-vinyl chloride copolymers, styrene-vinyl acetate copolymers, styrene-alkylacrylate (methyl, ethyl, butyl, octyl or phenyl acrylate) copolymers, styrene-alkylmethacrylate (methyl, ethyl, butyl or phenyl methacrylate) copolymers, styrene-methylchloroacrylate copolymers and styrene-acrylonitrile-alkyl acrylate copolymers. In these copolymers, the comonomer content will generally be up to 20% by weight. The present invention also relates to metallocene polystyrenes having a high melting point. Advantageously, the vinylaromatic resin is ABS and SAN/ABS blends.

The proportion of TPU in the TPU layer may have any value provided that it is greater than 1%, and advantageously at least 20%, by weight.

Mention may also be made of polyamide 11 or 12 blends containing, by weight, 10 to 40% of optionally functionalized polyolefin or of a blend of polyolefin and functionalized polyolefin.

Mention may also be made of blends (i) of polyolefin, or of polyolefin and of functionalized polyolefin, which contain (ii) 10 to 40% of polyamide 11 or 12.

With regard to the polyamide 2 layer, this is preferably made of PA-12, PA-11, a blend of PA-12 with a copolymer having polyamide blocks and polyether blocks, or a blend of PA-12, PA-11 and optionally an ethylene/alkyl acrylate/maleic anhydride copolymer.

The thicknesses of the layers may be 150 to 300 (polyamide 1)/100 to 400/50 to 200 μm. The thicknesses of the layers are advantageously 200 (polyamide 1)/300/100 μm. Of course, these thicknesses may be varied in order to adjust the compromise of properties (in particular, flexibility versus transparency and flexibility versus creep resistance). For example, the thickness of the internal layer may be increased in order to increase flexibility, or it may be decreased, in order to increase creep resistance and transparency.

The layers may contain standard additives, namely stabilizers, colorants, plasticizers, lubricants, nucleating agents, impact modifiers, softening agents, etc.

The structures of the invention may be manufactured by coextrusion. The flat coextrusion process may be calendering or casting or the like. It is also possible to extrude a layer (or 2 layers) and then deposit the other layers by lamination or coating. The interlayer and/or the polyamide 2 layer may be in the form of a woven or a nonwoven.

### EXAMPLES

TABLE 1

| | | Inter | | Scratch | Impact | Flex- | subli- | Transpar- | Screen | UV | Creep |
|---|---|---|---|---|---|---|---|---|---|---|---|
| Ex | Polyamide 1 | layer | Polyamide 2 | resist. | resist. | ibility | mation | ency | printing | resist. | resist. |
| 1 | BESNO 24 | PP + pPP | AESN0 14 | +++ | +++ | ++ | ++ | +++ | ++ | +++ | +++ |
| | TLCC | | | | | | | | | | |
| 2 | PA-11 + 25% | ″ | ″ | +++ | +++ | ++ | ++ | +++ | ++ | +++ | +++ |
| | IPDA, 12 | | | | | | | | | | |
| 3 | PA-11 + 10%, | ″ | ″ | +++ | +++ | ++ | ++ | +++ | ++ | ++ | |
| | IPDA, 12 | | | | | | | | | | |
| 4 | MB3751 | ″ | ″ | +++ | +++ | ++ | ++ | +++ | ++ | ++ | |
| 5 | PA-12 | ″ | ″ | ++ | ++ | ++ | ++ | + | ++ | ++ | |
| 6 | PA-12 + 15% | ″ | ″ | ++ | ++ | ++ | ++ | + | ++ | ++ | |
| | PA-10, 12 | | | | | | | | | | |
| 7 | BESN0 TL NB + BESN0 | ″ | ″ | +++ | +++ | ++ | ++ | ++ | ++ | +++ | |
| | 24 TLCC | | | | | | | | | | |
| 8 | CX7323 | ″ | ″ | +++ | ++ | + | ++ | +++ | ++ | | |
| 9 | PA/PACM.12 | ″ | ″ | +++ | ++ | + | ++ | +++ | ++ | | |
| 10 | TR90LX | ″ | ″ | +++ | ++ | + | ++ | +++ | ++ | | |
| 11 | TR90UV | ″ | ″ | +++ | + | + | ++ | +++ | ++ | | |
| 12 | PA/BMACM.12 | ″ | ″ | +++ | + | + | ++ | +++ | ++ | | |
| 13 | BESN0 TL NB + BESN0 | ″ | EX9200 | +++ | +++ | | ++ | ++ | + | +++ | |
| | 24 TLCC | | | | | | | | | | |
| 14 | PA-12 + 15% PA- | ″ | ″ | ++ | ++ | ++ | ++ | + | + | ++ | |
| | 10, 12 | | | | | | | | | | |
| 15 | PA-12 + 15% PA- | ″ | PA-12 + 15-40% | +++ | +++ | | ++ | ++ | + | +++ | |
| | 10, 12 | | PEBA40 | | | | | | | | |
| 16 | PA-12 + 15% PA- | ″ | PEBA40 + 15%-40% | +++ | +++ | | + | ++ | +++ | +++ | |
| | 10, 12 | | PA-12 | | | | | | | | |
| 17 | BESNO 24 | PP + gPP | PA 11 + 25% | +++ | +++ | | ++ | +++ | +++ | +++ | |
| | TLCC | | IPDA, 12 + 6% | | | | | | | | |
| | | | Lotader | | | | | | | | |
| | | | AX8840 | | | | | | | | |
| 18 | BESNO 24 | ″ | PA11 | +++ | +++ | | ++ | ++ | − | +++ | |
| | TLCC | | | | | | | | | | |
| 19 | PA-11 + 25%, | gPP | AESN0. 14 | +++ | ++ | ++ | ++ | ++ | ++ | +++ | +++ |
| | IPDA, 12 | | | | | | | | | | |
| 20 | PA-11 + 25%, | Ppco | ″ | +++ | +++ | ++ | ++ | +++ | ++ | +++ | +++ |
| | IPDA, 12 | gPPco | | | | | | | | | |
| 21 | PA-11 + 25%, | HDPE + gHDPE | ″ | +++ | +++ | ++ | ++ | ++ | ++ | +++ | ++ |
| | IPDA, 12 | gHDPE | | | | | | | | | |
| 22 | PA-11 + 25%, | L3210 | ″ | +++ | +++ | +++ | ++ | ++ | ++ | +++ | ++ |
| | IPDA, 12 | | | | | | | | | | |
| 23 | PA-11 + 25%, | L3410 | ″ | +++ | +++ | +++ | ++ | +++ | ++ | +++ | + |
| | IPDA, 12 | | | | | | | | | | |
| 24 | PA-11 + 25%, | Or.9314 | ″ | +++ | +++ | +++ | ++ | +++ | ++ | +++ | + |
| | IPDA, 12 | | | | | | | | | | |
| 25 | PA-11 + 25%, | TPU | ″ | +++ | +++ | +++ | ++ | +++ | ++ | + | +++ |
| | IPDA, 12 | | | | | | | | | | |
| 26 | PA-11 + 25%, | PEBA63 | ″ | +++ | +++ | ++ | ++ | ++ | ++ | ++ | +++ |
| | IPDA, 12 | | | | | | | | | | |
| 27 | PA-11 + 25%, | PEBA40 | ″ | +++ | +++ | +++ | ++ | +++ | ++ | ++ | ++ |
| | IPDA, 12 | | | | | | | | | | |
| 28 | BESN0 24 | Orevac | ″ | +++ | +++ | ++ | ++ | +++ | ++ | +++ | +++ |
| | TLCC | 18729 | | | | | | | | | |
| 29 | BESN0 24 | OREVAC | ″ | +++ | +++ | ++ | ++ | +++ | ++ | +++ | +++ |
| | TLCC | 18760 | | | | | | | | | |
| 30 | BESN0 24 | OREVAC | PA-12 + 12% | +++ | +++ | ++ | ++ | +++ | ++ | +++ | +++ |
| | TLCC | 18729 | PA-11 + 6% | | | | | | | | |
| | | | L3410 | | | | | | | | |
| 31 | BESN0 24 | OREVAC | PA-12 + 25IPDA, | +++ | +++ | ++ | ++ | +++ | ++ | +++ | +++ |
| | TLCC | 18729 | 12 + 12% | | | | | | | | |
| | | | PA-11 + 6% | | | | | | | | |
| | | | LUT3210 | | | | | | | | |
| 32 | BESN0 24 | BESN0 24 | PA-12 + 12% | +++ | +++ | + | ++ | +++ | ++ | +++ | +++ |
| | TLCC | TLCC + 9% | PA-11 + 6% | | | | | | | | |
| | | L3210 + 27% | L3410 | | | | | | | | |
| | | Ly7BA01 | | | | | | | | | |
| 33 | BESN0 24 | L3210 + 36% | PA-12 + 12% | +++ | +++ | ++ | ++ | ++ | ++ | +++ | ++ to |
| | TLCC | BESN0 | PA-11 + 6% | | | | | | | | +++ |
| | | 24 TLCC | L3410 | | | | | | | | |
| 34 | BESN0 24 | lldPE d911 + 16% | PA-12 + 12% | +++ | +++ | +++ | ++ | +++ | ++ | +++ | ++ to |
| | TLCC | lldPEg + 36% | PA-11 + 6% | | | | | | | | +++ |
| | | BESN0 24 | L3410 | | | | | | | | |
| | | TLCC | | | | | | | | | |
| 35 | BESN0 24 | lldPE d911 + 16% | PA-12 + 12% | +++ | +++ | +++ | ++ | ++ | ++ | +++ | ++ |
| | TLCC | L3210 | PA-11 + 6% | | | | | | | | |
| | | | L3410 | | | | | | | | |

NB: the blends are preferably manufactured during a prior compounding step, but may also be produced at the same time as the processing step.

Names of the products and definitions

| | |
|---|---|
| BESNO 24 TLCC | Atofina nylon-11: Rilsan BESNO 24 TLC CC |
| IPDA, 12 | Amorphous polyamide: IPDA, 12, condensation |
| | product of isophorone diamine and C12 acid |
| AESNO 14 | Atofina nylon-12: Rilsan AESNO 14 TL |
| MB3751 | Atofina: Rilsan MB3751 blend of PA-11 and 25% by |
| | weight of semiaromatic polyamide |
| PA-12 | Nylon-12 of MFI (235° C./5 kg) between 0.5 and 30 |
| PA-11 | Nylon-11 of MFI (235° C./5 kg) between 0.5 and 30 |
| PA-10,12 | Nylon-10,12 |
| BESNO TL NB | Atofina PA-11: Rilsan BESNO TL NB |
| CX7323 | Vestamid CX7323, a polyamide sold by Degussa and |
| | described in EP 619336 |
| PA/PACM.12 | Polyamide/PACM.12 blend |
| TR90LX | Ems Grilamid TR90LX, a polyamide sold by Ems |
| TR90UV | Ems Grilamid TR90UV, a polyamide sold by Ems |
| PA/BMACM.12 | Polyamide/BMACM.12 (also called polyamide/ |
| | MACM.12) blend |
| EX9200 | Degussa Vestamid EX9200, a polyamide sold by |
| | Degussa |
| PEBA40 | Atofina PEBAX1205, a copolymer having PA-12 |
| | blocks and PTMG blocks in proportions of 50/50 |
| PEBA63 | Atofina PEBAX6333, a copolymer having PA-12 |
| | blocks and PTMG blocks in proportions of 80/20 |
| PP | Polypropylene |
| gPP | Atofina Orevac CA100, a PP grafted with 1% maleic |
| | anhydride |
| Ly7BA01 | Atofina Lotryl 7BA01 (ethylene-butyl acrylate |
| | copolymer with 7% by weight of acrylate, with an MFI |
| | of 1 at 190° C. under 2.16 kg |
| lldPEg | lldPE grafted with maleic anhydride; DuPont brand |
| | name Fusabond MB528D |
| lldPE d911 | lldPE with a density of 911 and an MFI at 190° C. |
| | under 2.16 kg of 3; name: Clearflex CLBO, |
| | manufactured by Polimeri Europa |
| PPco | Atofina polypropylene PPC 3640 |
| gPPco | Atofina PPC 3640 grafted with 1% maleic anhydride |
| HDPE | Atofina Laqtène 2008SN60U, a high-density |
| | polyethylene |
| gHDPE | DuPont Fusabond MB100D, a maleic-grafted high- |
| | density polyethylene |
| L3210 | Atofina Lotader 3210, an ethylene/butylacrylate/ |
| | maleic anhydride copolymer of 5 MFI, containing 6% |
| | acrylate and 3% MAH |
| L3410 | Atofina Lotader 3410, an ethylene/butylacrylate/ |
| | maleic anhydride copolymer of 5 MFI, containing 18% |
| | acrylate and 3% MAH |
| Or.9314 | Atofina Orevac 9314, an ethylene/vinyl acetate/maleic |
| | anhydride terpolymer |
| TPU | Elastoran Elastollan 1185A |
| OREVAC 18729 | Maleic-grafted PP sold by Atofina |
| OREVAC 18760 | Maleic-grafted PP sold by Atofina |
| LOT AX8840 | Ethylene/glycidyl methacrylate copolymer in propor- |
| | tions by weight of 92/8, of MFI (190° C./2.16 kg) |
| | between 4 and 6. |

Definitions for Table 1

| | |
|---|---|
| Scratch | Ability to withstand scratching and to retain a shiny |
| resistance | appearance |
| Impact | Ability to withstand an impact, a blow with a ski edge, |
| resistance | strong vibration, particularly at low temperatures |
| Flexibility | Flexibility of the sheet |
| Sublimation | Ability to be easily decorated by sublimation (good |
| | pigment transfer and very sharp decoration) |
| Screen printing | Ability to bond well to screen-printing inks |
| UV resistance | Ability to withstand UV radiation |
| Creep resistance | Ability to withstand the various hot operations during |
| | manufacture of a ski, without the sheet deforming |
| | unacceptably |

The polymers are chosen from those suitable for sheet extrusion, that is to say typically polymers that are rather viscous, and therefore of quite high molecular weight;
In the case of decoration by sublimation, the sublimed face is typically flame-brushed beforehand, so that subsequent adhesion to the ski substrate is better;
The layer thicknesses are 200/300/100 μm;
These thicknesses may of course be varied in order to adjust the compromise of properties;
For example, the thickness of the interlayer may be increased in order to increase flexibility, or else it may be decreased in order to increase creep resistance and transparency.

1. A transparent multiplayer structure comprising:
a) a first polyamide layer (polyamide 1);
b) an interlayer; and
c) a second polyamide layer (polyamide 2).

2. The structure of claim 1 wherein the polyamide 1 layer comprises at least one polyamide chosen from semiaromatic or semicycloaliphatic PAs and aliphatic polyamides.

3. The structure of claim 2, in which the aliphatic polyamides comprise PA-11; PA-12; the aliphatic polyamides resulting from the condensation of an aliphatic diamine having 6 to 12 carbon atoms; an aliphatic diacid having 9 to 12 carbon atoms; or 11/12 copolyamides having either more than 90 percent of 11 units or more than 90 percent of 12 units.

4. The structure of claim 1 in which the polyamide 1 layer further comprises copolymers having polyamide blocks and polyether blocks.

5. The structure of claim 1 in which the interlayer is a coextrusion tie.

6. The structure of claim 1 in which the interlayer is made of a thermoplastic polyurethane (TPU).

7. The structure of claim 1 further comprising a foam or resin bonded directly to the transparent multiplayer polyamide 1/interlayer/polyamide 2 structure.

8. The structure of claim 7 wherein said structure is decorated by sublimation of inks into the polyamide 1 layer.

9. The structure of claim 7 comprising a ski.

10. A method for forming the structure of claim 7 comprising overmoulding of the foam or resin to the polyamide 1/interlayer/polyamide 2 structure placed in a mould, the polyamide 1 layer being adjacent to the mould wall, the polyamide 1 layer being on the outside.
